(19) United States
(12) Patent Application Publication
(10) Pub. No.: US 2022/0082845 A1
(43) Pub. Date: Mar. 17, 2022

(54) OPTICAL SYSTEM FOR LINE GENERATOR AND LINE GENERATOR

(71) Applicant: NALUX CO., LTD., Osaka (JP)

(72) Inventors: Kenta ISHII, Osaka (JP); Daisuke SEKI, Osaka (JP)

(73) Assignee: NALUX CO., LTD., Osaka (JP)

(21) Appl. No.: 17/534,648

(22) Filed: Nov. 24, 2021

Related U.S. Application Data
(63) Continuation of application No. PCT/JP2020/028455, filed on Jul. 22, 2020.
(60) Provisional application No. 62/883,219, filed on Aug. 6, 2019.

(51) Int. Cl. G02B 27/09; G01C 3/02

(52) U.S. Cl. CPC G02B 27/0927; G01C 3/02; G02B 27/0966; G02B 27/0961

(57) ABSTRACT

The optical system includes an optical element having a curvature in a first direction alone; and first and second lens array surfaces. Each of the lens array surfaces is provided with plural toroidal lens surfaces arranged in a second direction orthogonal to the first direction, the plural lens surfaces have a curvature mainly in the second direction, any lens surface on one of the lens array surfaces corresponds to one of the toroidal lens surfaces on the other, the direction of a first straight line connecting the vertexes of two toroidal lens surfaces corresponding to each other is orthogonal to the second direction, and in a cross section containing the first straight line and a second straight line that is in the second direction, one of the two toroidal lens surfaces is configured so as to form an imaging surface of the other for the object point at infinity.

### CROSS REFERENCE TO RELATED APPLICATION

This is a Continuation of International Patent Application No. PCT/JP2020/028455 filed Jul. 22, 2020, which designates the U.S., and which claims priority from U.S. Provisional Patent Application No. 62/883,219, dated Aug. 6, 2019. The contents of these applications are hereby incorporated by reference.

### TECHNICAL FIELD

The present invention relates to an optical system for a line generator and to a line generator.

### BACKGROUND ART

Line generators that generate a line by the use of a light beam are widely used for determining dimensions of an object, inspecting flaws and defects on a surface of an object or the like.

Some of conventional line generators use an optical element such as a Powell lens (for example patent documents 1 and 2). The uniformity of intensity in the longitudinal direction of lines generated by such line generators, however, is not high. Further, adjustments of the optical systems of such line generators require a lot of time.

Further, some of conventional line generators use a cylindrical lens to determine intensity in the longitudinal direction of lines (for example patent document 3). In such line generators, however, an optical system including a light source must be redesigned in order to change intensity of light of generated lines, and therefore the change cannot be accomplished with ease.

Under the situation described above, an optical system for a line generator and a line generator, the optical system being easy to adjust, the uniformity of intensity in the longitudinal direction of lines generated by the line generator being high, and intensity of light of lines of the line generator being easy to change has not been developed.

Accordingly, there is a need for an optical system for a line generator and a line generator, the optical system being easy to adjust, the uniformity of intensity in the longitudinal direction of lines generated by the line generator being high, and intensity of light of lines of the line generator being easy to change.

### PRIOR ART DOCUMENT

Patent Document
Patent document 1: JP2009259711A
Patent document 2: JP2008058295A
Patent document 3: JP2007179823A

The technical problem to be solved by the present invention is to provide an optical system for a line generator and a line generator, the optical system being easy to adjust, the uniformity of intensity in the longitudinal direction of lines generated by the line generator being high, and intensity of light of lines of the line generator being easy to change.

### SUMMARY OF INVENTION

An optical system for a line generator according to a first aspect of the present invention is an optical system for a line generator that generates a line using a light beam. The optical system includes: an optical element having a curvature in a first direction alone; and first and second lens array surfaces. Each of the first and second lens array surfaces is provided with plural toroidal lens surfaces arranged in a line in a second direction orthogonal to the first direction, each of the plural toroidal lens surfaces has a curvature mainly in the second direction, any toroidal lens surface on one of the first and second lens array surfaces corresponds to one of the toroidal lens surfaces on the other, the direction of a first straight line connecting the vertexes of two toroidal lens surfaces corresponding to each other is orthogonal to the second direction, and in a cross section containing the first straight line and a second straight line that is in the second direction and orthogonal to the first straight line, one of the two toroidal lens surfaces is configured so as to form an imaging surface of the other for the object point at infinity.

In the optical system for a line generator according to the present aspect, in a cross section containing the first straight line connecting the vertexes of a pair of toroidal lens surfaces corresponding to each other and a second straight line that is in the second direction and orthogonal to the first straight line, one of the pair of toroidal lens surfaces is configured so as to form an imaging surface of the other for the object point at infinity. Thus, the Köhler illumination is formed. Accordingly, the optical system according to the present aspect has the following features.

In the optical system according to the present aspect, it is not necessary to collimate in the second direction a light beam entering the first and second lens array surfaces.

No other adjustments than adjustments of a positional relationship between the optical element and the light source that has a curvature in the first direction alone are required by the optical system according to the present aspect, and the optical system is easier to adjust as compared with conventional optical systems.

The optical system according to the present invention is configured so as to form the Köhler illumination in the second direction, and therefore the uniformity of intensity of light in the second direction is high.

In the optical system for a line generator according to a first embodiment of the first aspect of the present invention, a curvature in the first direction of each of the toroidal lens surfaces is 0 or ten times less than the curvature in the second direction.

A pair of toroidal lens surfaces corresponding to each other determines the extent in the longitudinal direction of a line of a light beam by the curvature. On the other hand, the width of the light beam depends on the curvature in the first direction, which is 0 or smaller as compared with the curvature in the second direction.

In the optical system for a line generator according to a second embodiment of the first aspect of the present invention, a curvature in the first direction of each of the toroidal lens surfaces is determined so as to correct aberrations of the optical element.

In the optical system according to the present invention, the shape in the first direction of each of the toroidal lens surfaces does not affect a distribution of intensity of light in the second direction. Accordingly, by providing a curvature in the first direction of each of the toroidal lens surfaces, the curvature being smaller as compared with that in the second direction, residual aberrations of the optical element having a curvature in the first direction alone can be corrected to improve the uniformity of intensity of light and the concentration of light in the width direction of a line.

In the optical system for a line generator according to a third embodiment of the first aspect of the present invention, the first and second lens array surfaces are provided on a single lens.

In the optical system for a line generator according to a fourth embodiment of the first aspect of the present invention, the first and second lens array surfaces are provided respectively on different lenses.

In the optical system for a line generator according to a fifth embodiment of the first aspect of the present invention, the optical element is a cylindrical lens.

In the optical system for a line generator according to a sixth embodiment of the first aspect of the present invention, the optical element is a cylindrical mirror.

A line generator according to a second aspect of the present invention is provided with any one of the above-described optical systems for a line generator and a light source.

In the line generator according to a first embodiment of the second aspect of the present invention, the length in the second direction of the light source is greater than the length in the first direction.

In the line generator according to a second embodiment of the second aspect of the present invention, the light source is composed of plural light sources arranged in a line in the second direction.

The optical system of the present invention is configured such that the Köhler illumination is formed in the second direction, and therefore a distribution of relative values of intensity of light in the longitudinal direction of a line is not affected by an intensity distribution in the second direction of the light source. Accordingly, the absolute value of intensity of light can be increased by enlarging the size of the light source in the second direction or arranging plural light sources in a line in the second direction while the distribution of relative values of intensity of light in the longitudinal direction of a line is kept uniform.

### BRIEF DESCRIPTION OF DRAWINGS

FIG. 1 illustrates toroidal surfaces of the first lens array surface and the second lens array surface;

FIG. 2 shows paths of rays of light in the xz cross section of the line generator of Example 1;

FIG. 3 shows paths of rays of light in the yz cross section of the line generator of Example 1;

FIG. 4 shows an intensity distribution in the x-axis direction of a light beam that has passed through the line generator of Example 1;

FIG. 5 shows an intensity distribution in the y-axis direction of a light beam that has passed through the line generator of Example 1;

FIG. 6 shows paths of rays of light in the xz cross section of the line generator of Example 2;

FIG. 7 shows paths of rays of light in the yz cross section of the line generator of Example 2;

FIG. 8 shows an intensity distribution in the x-axis direction of a light beam that has passed through the line generator of Example 2;

FIG. 9 shows an intensity distribution in the y-axis direction of a light beam that has passed through the line generator of Example 2;

FIG. 10 shows paths of rays of light in the xz cross section of the line generator of Example 3;

FIG. 11 shows paths of rays of light in the yz cross section of the line generator of Example 3;

FIG. 12 shows an intensity distribution in the x-axis direction of a light beam that has passed through the line generator of Example 3;

FIG. 13 shows an intensity distribution in the y-axis direction of a light beam that has passed through the line generator of Example 3;

FIG. 14 shows paths of rays of light in the xz cross section of the line generator of Example 4;

FIG. 15 shows paths of rays of light in the yz cross section of the line generator of Example 4;

FIG. 16 shows an intensity distribution in the x-axis direction of a light beam that has passed through the line generator of Example 4;

FIG. 17 shows an intensity distribution in the y-axis direction of a light beam that has passed through the line generator of Example 4;

FIG. 18 shows paths of rays of light in the xz cross section of the line generator of Example 5;

FIG. 19 shows paths of rays of light in the yz cross section of the line generator of Example 5;

FIG. 20 shows an intensity distribution in the x-axis direction of a light beam that has passed through the line generator of Example 5;

FIG. 21 shows an intensity distribution in the y-axis direction of a light beam that has passed through the line generator of Example 5;

FIG. 22 shows paths of rays of light in the xz cross section of the line generator of Example 6;

FIG. 23 shows paths of rays of light in the yz cross section of the line generator of Example 6;

FIG. 24 shows an intensity distribution in the x-axis direction of a light beam that has passed through the line generator of Example 6;

FIG. 25 shows an intensity distribution in the y-axis direction of a light beam that has passed through the line generator of Example 6;

FIG. 26 shows paths of rays of light in the xz cross section of the line generator of Example 7;

FIG. 27 shows paths of rays of light in the yz cross section of the line generator of Example 7;

FIG. 28 shows an intensity distribution in the x-axis direction of a light beam that has passed through the line generator of Example 7;

FIG. 29 shows an intensity distribution in the y-axis direction of a light beam that has passed through the line generator of Example 7;

FIG. 30 shows paths of rays of light in the xz cross section of the line generator of Example 8;

FIG. 31 shows paths of rays of light in the yz cross section of the line generator of Example 8;

FIG. 32 shows an intensity distribution in the x-axis direction of a light beam that has passed through the line generator of Example 8;

FIG. 33 shows an intensity distribution in the y-axis direction of a light beam that has passed through the line generator of Example 8;

FIG. 34 shows paths of rays of light in the xy cross section of the line generator of Example 9;

FIG. 35 shows paths of rays of light in the yz cross section of the line generator of Example 9;

FIG. 36 shows paths of rays of light in the zx cross section of the line generator of Example 9;

FIG. 37 shows an intensity distribution in the line width direction (the z-axis direction) of a light beam that has passed through the line generator of Example 9;

FIG. 38 shows an intensity distribution in the line longitudinal direction (the y-axis direction) of a light beam that has passed through the line generator of Example 9;

FIG. 39 shows paths of rays of light in the xy cross section of the line generator of Example 10;

FIG. 40 shows paths of rays of light in the yz cross section of the line generator of Example 10;

FIG. 41 shows paths of rays of light in the zx cross section of the line generator of Example 10;

FIG. 42 shows an intensity distribution in the line width direction (the z-axis direction) of a light beam that has passed through the line generator of Example 10;

FIG. 43 shows an intensity distribution in the line longitudinal direction (the y-axis direction) of a light beam that has passed through the line generator of Example 10;

FIG. 44 shows paths of rays of light in the xy cross section of the line generator of Example 11;

FIG. 45 shows paths of rays of light in the yz cross section of the line generator of Example 11;

FIG. 46 shows paths of rays of light in the zx cross section of the line generator of Example 11;

FIG. 47 shows an intensity distribution in the line width direction (the z-axis direction) of a light beam that has passed through the line generator of Example 11;

FIG. 48 shows an intensity distribution in the line longitudinal direction (the y-axis direction) of a light beam that has passed through the line generator of Example 11;

FIG. 49 shows paths of rays of light in the xy cross section of the line generator of Example 12;

FIG. 50 shows paths of rays of light in the yz cross section of the line generator of Example 12;

FIG. 51 shows paths of rays of light in the zx cross section of the line generator of Example 12;

FIG. 52 shows an intensity distribution in the line width direction (the z-axis direction) of a light beam that has passed through the line generator of Example 12;

FIG. 53 shows an intensity distribution in the line longitudinal direction (the y-axis direction) of a light beam that has passed through the line generator of Example 12;

FIG. 54 shows paths of rays of light in the xz cross section of the line generator of Example 13;

FIG. 55 shows paths of rays of light in the yz cross section of the line generator of Example 13;

FIG. 56 shows an intensity distribution in the line width direction (the x-axis direction) on an illuminated surface at the distance of 3000 millimeters from the light source of a light beam that has passed through the line generator of Example 13;

FIG. 57 shows an intensity distribution in the line longitudinal direction (the y-axis direction) on an illuminated surface at the distance of 3000 millimeters from the light source of a light beam that has passed through the line generator of Example 13;

FIG. 58 shows paths of rays of light in the xz cross section of the line generator of Example 14;

FIG. 59 shows paths of rays of light in the yz cross section of the line generator of Example 14;

FIG. 60 shows an intensity distribution in the x-axis direction of a light beam that has passed through the line generator of Example 14; and

FIG. 61 shows an intensity distribution in the y-axis direction of a light beam that has passed through the line generator of Example 14.

### DESCRIPTION OF EMBODIMENTS

A line generator according to the present invention is composed of a light source 200, an optical element 300 used for determining the width of a line generated by the line generator, a first lens array surface 110 and a second lens array surface 120 used for determining a beam divergence angle in the longitudinal direction of the line. The light source 200 can be a laser light source or a light emitting diode light source. Each of the first lens array surface 110 and the second lens array surface 120 is composed of plural toroidal lens surfaces arranged in a line in one direction on a flat surface.

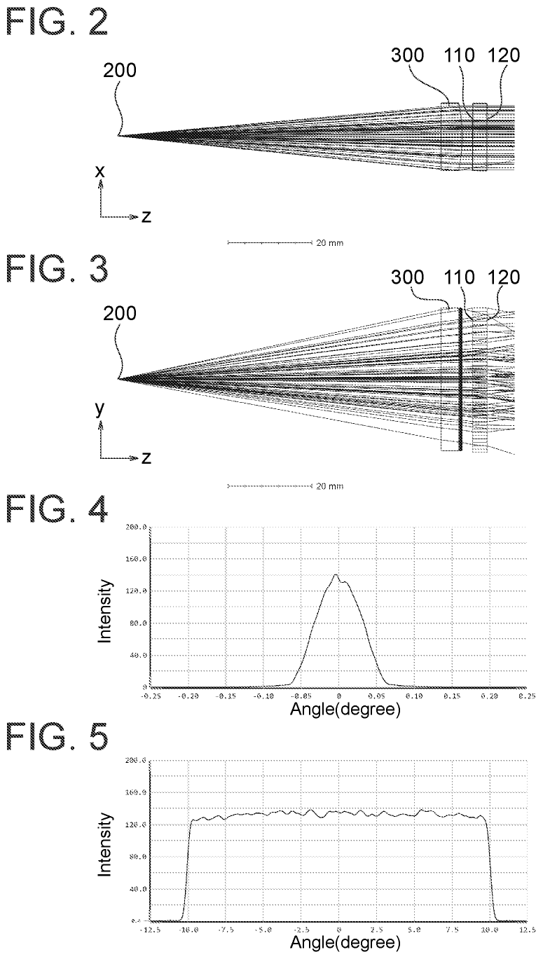

FIG. 2 and FIG. 3 show paths of rays of light of the line generator of Example 1, which will be described later. The optical element 300 of Example 1 is a cylindrical lens. The direction in which the cylindrical lens has a curvature is defined as an x-axis direction, the direction in which the cylindrical lens has no curvature is defined as a y-axis direction and the direction that is orthogonal to the x-axis direction and the y-axis direction is defined as a z-axis direction. FIG. 2 and FIG. 3 show an xz cross section and a yz cross section respectively. In the present example, the x-axis direction is the width direction of a line generated by the line generator, and the y-axis direction is the longitudinal direction of the line generated by the line generator.

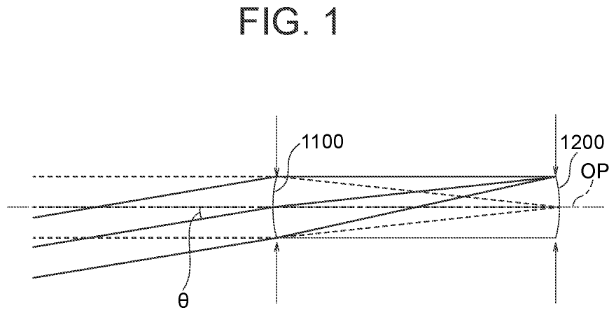

FIG. 1 illustrates toroidal lens surfaces of the first lens array surface 110 and the second lens array surface 120. The toroidal lens surface of the first lens array surface 110 on the light entry side is represented by 1100, and the toroidal lens surface of the second lens array surface 120 on the light exit side is represented by 1200. The toroidal lens surface 1200 corresponds to the toroidal lens surface 1100.

The straight line connecting the vertexes of the lens surface 1100 and the lens surface 1200 is defined as an optical axis OP. The direction of the optical axis agrees with the z-axis direction shown in FIG. 2 and FIG. 3. FIG. 1 shows a cross section containing the optical axis OP and the longitudinal direction of a line generated by the line generator. The cross section is the yz cross section shown by FIG. 3.

In FIG. 1, a parallel light beam that travels parallel to the optical axis OP and enters the lens surface 1100 is represented by broken lines, and a parallel light beam that is incident onto the lens surface 1100 at the maximum value of θ with respect to the optical axis OP is represented by solid lines.

On the other hand, when the power of the lens surface 1100 is represented by ϕ1, the power of the lens surface 1200 is represented by ϕ2, and the power of the lens surface 1100 and the lens surface 1200 is represented by ϕ, the following relationship holds.

$$ϕ = ϕ 1 + ϕ 2 - τ \cdot ϕ 1 \cdot ϕ 2$$

τ represents converted distance between the lens surfaces, which is expressed by the following expression where t represents distance between the lens surfaces and n represents refractive index of the lens.

$$τ = t / n$$

When the radius of curvature of the lens surface 1100 is represented by R1, the power ϕ1 of the lens surface 1100 is expressed by the following expression.

$$ϕ 1 = ( n - 1 ) / R 1$$

When the radius of curvature of the lens surface 1200 is represented by R2, the power ϕ2 of the lens surface 1200 is expressed by the following expression.

$$ϕ 2 = - ( n - 1 ) / R 2$$

According to the present invention, the lens surface 1100 and the lens surface 1200 are configured so as to form the Köhler illumination. The condition of the Köhler illumination is as bellow.

$$ϕ = ϕ 1 = ϕ 2$$

Accordingly, the following relationship holds.

$$ϕ 1 - τ \cdot ϕ 1 \cdot ϕ 1 = 0$$

From the above-described relationship, the following relationship can be obtained.

$$ϕ = ϕ 1 = ϕ 2 = 1 / τ$$

When the combined focal length of the lens surface 1100 and the lens surface 1200 is represented by f, the following relationship holds.

$$f = 1 / ϕ = τ = t / n$$

Thus, the lens surface 1100 and the lens surface 1200 realizing the Köhler illumination are configured such that one of them is an imaging surface of the other for the object point at infinity, and therefore a parallel light beam entering the lens surface 1100 is collected on the lens surface 1200.

When the aperture width of the lens surface 1100 and the aperture width of the lens surface 1200 are represented by P, and the maximum value of angle of a ray of light that enters the lens surface 1100 and the maximum value of angle of a ray of light that exits from the lens surface 1200 are represented by θ in FIG. 1, the following relationship holds.

$$P = 2 f \cdot tan θ$$

Thus, the lens surface 1100 and the lens surface 1200 spread light from the light source in a range of ±θ with respect to the optical axis. By the angle θ, the extent in the longitudinal direction of a line of a light beam generated by the line generator is determined, and the length of the line on an illuminated surface is determined. Further, the lens surface 1100 and the lens surface 1200 are configured so as to form the Köhler illumination, and therefore the uniformity of intensity distribution in the longitudinal direction of the line is very high.

Further, the following relationship holds concerning refractive index and radius of curvature.

$$ϕ 1 = \frac{n - 1}{R 1} = \frac{1}{τ} = \frac{n}{t}$$

Further, the following relationship holds.

$$t = ( \frac{n}{n - 1} ) \cdot R 1$$

An optical system according to the present invention generates a line with a light beam. The optical system according to the present invention is provided with the optical element 300 that has a curvature in a first direction (the x-axis direction) alone and the first and second lens array surfaces 110 and 120. Each of the first and second lens array surfaces 110 and 120 is provided with plural toroidal lens surfaces arranged in a line in a second direction (the y-axis direction) perpendicular to the first direction. Each of the plural toroidal lens surfaces has a curvature mainly in the second direction. Any toroidal lens surface of one of the first and second lens array surfaces corresponds to a toroidal lens surface of the other, and the direction of a first straight line (the optical axis OP in FIG. 1) connecting the vertexes of the two toroidal lens surfaces 1100 and 1200 that correspond to each other is orthogonal to the second direction. In a cross section containing the first straight line and a second straight line that is in the second direction and orthogonal to the first straight line, one 1100 or 1200 of the two toroidal lens surfaces is an imaging surface of the other 1200 or 1100 for the object point at infinity.

The optical element 300 that has a curvature in the first direction (the x-axis direction) alone is a cylindrical lens or a cylindrical mirror. The optical element 300 that has a curvature in the first direction alone determines the width of a line of a light beam generated by the line generator.

The first lens array surface 110 and the second lens array surface 120 determine the extent in the longitudinal direction of a line of a light beam generated by the line generator.

The optical system is configured such that in a plane containing the optical axis connecting the vertexes of two toroidal lens surfaces 1100 and 1200 that corresponds to each other and a straight line that is orthogonal to the optical axis and in the second direction (the y-axis direction), one of the pair of toroidal lens surfaces corresponding to each other is an imaging surface of the other for the object point at infinity and the Köhler illumination is formed. Accordingly, the optical system according to the present invention has the following features.

In the optical system of the present invention, it is not necessary to collimate in the second direction a light beam entering the first and second lens array surfaces.

No other adjustments than adjustments of a positional relationship between the light source 200 and the optical element 300 that has a curvature in the first direction alone are required by the optical system of the present invention, and the optical system is easier to adjust as compared with conventional optical systems.

The optical system of the present invention is configured such that the Köhler illumination is formed in the second direction, and therefore the uniformity of intensity of light in the second direction is high.

In the optical system of the present invention, the shape in the first direction of the toroidal lens surfaces has no influence on intensity distribution of light in the second direction. Accordingly, by providing a curvature in the first direction on each of the toroidal lens surfaces, the curvature being smaller than that in the second direction, residual aberrations of the optical element that has a curvature in the first direction alone can be corrected to improve the uniformity of intensity of light and the concentration of light in the width direction of a line.

The optical system of the present invention is configured such that the Köhler illumination is formed in the second direction, and therefore a distribution of relative values of intensity of light in the longitudinal direction of a line is not affected by an intensity distribution in the second direction of the light source. Accordingly, the absolute value of intensity of light can be increased by enlarging the size of the light source in the second direction or arranging plural light source units in a line in the second direction while the distribution of relative values of intensity of light in the longitudinal direction of a line is kept uniform.

Examples of the present invention will be described below. Each line generator is composed of the light source 200, the optical element 300 that determines the width of a line and the first and second lens array surfaces (110 and 120) that determine the extent in the longitudinal direction of a line of a light beam and determine the length of the line.

The light source 200 can be a laser light source or a light emitting diode light source as described above. The luminance of the light source is 1 kw/cm².

The optical element 300 that determines the extent in the width direction of a line of a light beam is a cylindrical lens or a cylindrical mirror, each of which has a curvature in one direction alone. An x-axis is defined in the direction in which the optical element 300 has a curvature, and a y-axis is defined in the direction in which the optical element 300 has no curvature, and a z-axis is determined such that it is orthogonal to the x-axis and the y-axis. Coordinate Sx in the z-axis direction of a surface of the optical element 300 with respect to the vertex of the cylindrical lens or the center of the cylindrical mirror is represented by the following expression.

$${S}_{x} = \frac{{c}_{x} {x}^{2}}{1 + \sqrt{1 - ( 1 + k ) {c}_{x}^{2} {x}^{2}}} + \sum {A}_{i} {x}^{i}$$

Curvature cₓ can be expressed as below using radius of curvature Rₓ.

$${c}_{x} = \frac{1}{{R}_{x}}$$

k represents the conic constant, Ai represents aspherical coefficients, i represents 0 or natural numbers.

The lens surfaces 1100 and 1200 that determine the extent in the longitudinal direction of a line of a light beam will be described. The straight line connecting the vertexes of the lens surfaces 1100 and 1200 is defined as a z-axis. The direction in which the lens surfaces 1100 and 1200 have a relatively great curvature is defined as a y-axis, and an x-axis that is orthogonal to the y-axis and the z-axis is defined. How z-coordinate of each of the lens surfaces 1100 and 1200 changes depending on x-coordinate with respect to the vertex of each lens surface can be represented by the following expression.

$${S}_{x} = \frac{{c}_{x} {x}^{2}}{1 + \sqrt{1 - ( 1 + k ) {c}_{x}^{2} {x}^{2}}} + \sum {A}_{i} {x}^{i}$$

Curvature cₓ can be expressed as below using radius of curvature Rₓ.

$${c}_{x} = \frac{1}{{R}_{x}}$$

How z-coordinate of each of the lens surfaces 1100 and 1200 changes depending on y-coordinate with respect to the vertex of each lens surface can be represented by the following expression.

$${S}_{y} = \frac{{c}_{y} {y}^{2}}{1 + \sqrt{1 - ( 1 + k ) {c}_{y}^{2} {y}^{2}}} + \sum {B}_{i} {y}^{i}$$

Curvature c_{y} can be expressed as below using radius of curvature R_{y}.

$${c}_{y} = \frac{1}{{R}_{y}}$$

Accordingly, z-coordinate of each of the lens surfaces 1100 and 1200 with respect to the vertex of each lens surface can be represented by the following expression.

$$S = {S}_{x} + {S}_{y}$$

### Example 1

The optical element 300 used for determining the width of a line of the line generator of Example 1 is a cylindrical lens. Lens array surfaces 110 and 120 are provided respectively on the light entry side surface and on the light exit side surface of a single lens array element.

FIG. 2 shows paths of rays of light in the xz cross section of the line generator of Example 1.

FIG. 3 shows paths of rays of light in the yz cross section of the line generator of Example 1.

Numerical data of Example 1 are shown below.

| Distance from light source: | | 77 | mm |
|---|---|---|---|
| Cylindrical lens: | Light entry side surface | Rx = infinite | |
| | Light exit side surface | Rx = −41.35mm | |
| | Center thickness | 5 | mm |
| | Refractive index | 1.509 | |
| Distance between elements: | | 2.5 | mm |
| Lens array element: | Light entry side surface | Ry = 1.15mm | |
| | (lens surface 1100) | k = −0.49 | |
| | Light exit side surface | Ry = −1.15 mm | |
| | (lens surface 1200) | k = −0.49 | |
| | Center thickness | 3.48 | mm |
| | Lens pitch in array | 0.8 | mm |
| | Refractive index | 1.489 | |
| Light source: | Size | 0.1 mm × 0.1 mm | |
| Size of aperture: | x-axis direction | 16 | mm |
| | y-axis direction | 34 | mm |

The lens surfaces 1100 on the lens array surface 110 and the lens surfaces 1200 on the lens array surface 120, each of which has a curvature in the y-axis direction alone, are placed respectively in a line in the y-axis direction at intervals of 0.8 millimeters.

FIG. 4 shows an intensity distribution in the x-axis direction of a light beam that has passed through the line generator of Example 1. The horizontal axis of FIG. 4 indicates angle of a ray of light with respect to the z-axis in the xz cross section. The unit of angle is degree. The vertical axis of FIG. 4 indicates intensity of light. The unit of intensity of light is Watt/steradian.

FIG. 5 shows an intensity distribution in the y-axis direction of a light beam that has passed through the line generator of Example 1. The horizontal axis of FIG. 5 indicates angle of a ray of light with respect to the z-axis in the yz cross section. The unit of angle is degree. The vertical axis of FIG. 5 indicates intensity of light. The unit of intensity of light is Watt/steradian.

### Example 2

The optical element 300 used for determining the width of a line of the line generator of Example 2 is a cylindrical lens. Lens array surfaces 110 and 120 are provided respectively on the light entry side surface and on the light exit side surface of a single lens array element.

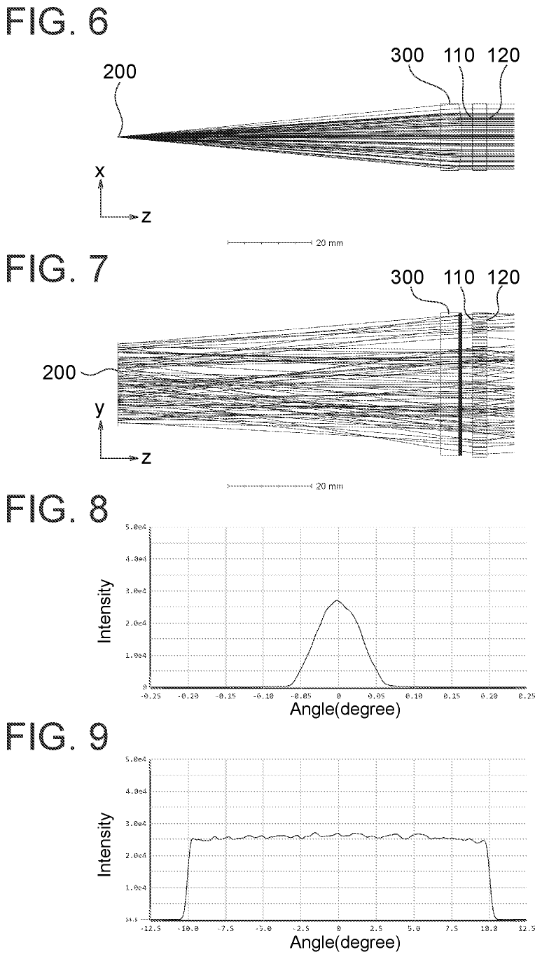

FIG. 6 shows paths of rays of light in the xz cross section of the line generator of Example 2.

FIG. 7 shows paths of rays of light in the yz cross section of the line generator of Example 2.

Numerical data of Example 2 are shown below.

| Distance from light source: | | 77 | mm |
|---|---|---|---|
| Cylindrical lens: | Light entry side surface | Rx = infinite | |
| | Light exit side surface | Rx = −41.35 mm | |
| | Center thickness | 5 | mm |
| | Refractive index | 1.509 | |
| Distance between elements: | | 2.5 | mm |
| Lens array element: | Light entry side surface | Ry = 1.15 mm | |
| | (lens surface 1100) | k = −0.49 | |
| | Light exit side surface | Ry = −1.15 mm | |
| | (lens surface 1200) | k = −0.49 | |
| | Center thickness | 3.48 | mm |
| | Lens pitch in array | 0.8 | mm |
| | Refractive index | 1.489 | |
| Light source: | Size | 0.1 mm × 20 mm | |
| Size of aperture: | x-axis direction | 16 | mm |
| | y-axis direction | 34 | mm |

The lens surfaces 1100 on the lens array surface 110 and the lens surfaces 1200 on the lens array surface 120, each of which has a curvature in the y-axis direction alone, are placed respectively in a line in the y-axis direction at intervals of 0.8 millimeters.

FIG. 8 shows an intensity distribution in the x-axis direction of a light beam that has passed through the line generator of Example 2. The horizontal axis of FIG. 8 indicates angle of a ray of light with respect to the z-axis in the xz cross section. The unit of angle is degree. The vertical axis of FIG. 8 indicates intensity of light. The unit of intensity of light is Watt/steradian.

FIG. 9 shows an intensity distribution in the y-axis direction of a light beam that has passed through the line generator of Example 2. The horizontal axis of FIG. 9 indicates angle of a ray of light with respect to the z-axis in the yz cross section. The unit of angle is degree. The vertical axis of FIG. 9 indicates intensity of light. The unit of intensity of light is Watt/steradian.

The cylindrical lens, the lens array surface 110 and the lens array surface 120 of Example 2 are identical respectively with the cylindrical lens, the lens array surface 110 and the lens array surface 120 of Example 1. The light source of Example 2 is enlarged in the y-axis direction as compared with the light source of Example 1 as shown in FIG. 7. The shapes of intensity distribution in the x-axis direction and in the y-axis direction of Example 2 are similar respectively to the shapes of intensity distribution in the x-axis direction and in the y-axis direction of Example 1. On the other hand, the intensity of light of Example 2 is greater than the intensity of light of Example 1. Thus, by enlarging the light source in the y-axis direction, the intensity of light can be increased without changing the shapes of intensity distribution.

### Example 3

The optical element 300 used for determining the width of a line of the line generator of Example 3 is a cylindrical lens. Lens array surfaces 110 and 120 are provided respectively on the light entry side surface and on the light exit side surface of a single lens array element.

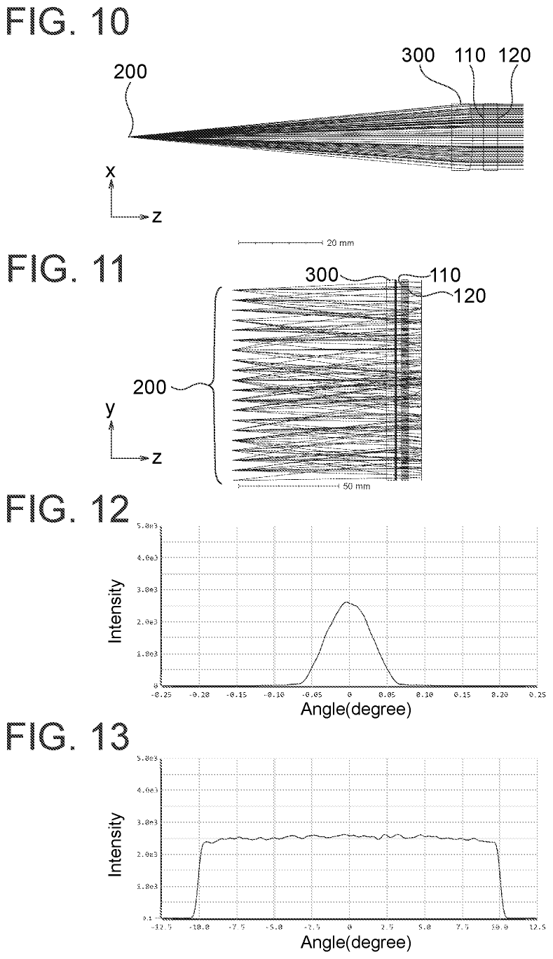

FIG. 10 shows paths of rays of light in the xz cross section of the line generator of Example 3.

FIG. 11 shows paths of rays of light in the yz cross section of the line generator of Example 3.

Numerical data of Example 3 are shown below.

| Distance from light source: | | 77 | mm |
|---|---|---|---|
| Cylindrical lens: | Light entry side surface | Rx = infinite | |
| | Light exit side surface | Rx = −41.35 mm | |
| | Center thickness | 5 | mm |
| | Refractive index | 1.509 | |
| Distance between elements: | | 2.5 | mm |
| Lens array element: | Light entry side surface | Ry = 1.15 mm | |
| | (lens surface 1100) | k = −0.49 | |
| | Light exit side surface | Ry = −1.15 mm | |
| | (lens surface 1200) | k = −0.49 | |
| | Center thickness | 3.48 | mm |
| | Lens pitch in array | 0.8 | mm |
| | Refractive index | 1.489 | |
| Light source: | Size | 0.1 mm × 0.1 mm | |
| | Light source pitch | 5 | mm |
| Size of aperture: | x-axis direction | 16 | mm |
| | y-axis direction | 100 | mm |

The lens surfaces 1100 on the lens array surface 110 and the lens surfaces 1200 on the lens array surface 120, each of which has a curvature in the y-axis direction alone, are placed respectively in a line in the y-axis direction at intervals of 0.8 millimeters.

FIG. 12 shows an intensity distribution in the x-axis direction of a light beam that has passed through the line generator of Example 3. The horizontal axis of FIG. 12 indicates angle of a ray of light with respect to the z-axis in the xz cross section. The unit of angle is degree. The vertical axis of FIG. 12 indicates intensity of light. The unit of intensity of light is Watt/steradian.

FIG. 13 shows an intensity distribution in the y-axis direction of a light beam that has passed through the line generator of Example 3. The horizontal axis of FIG. 13 indicates angle of a ray of light with respect to the z-axis in the yz cross section. The unit of angle is degree. The vertical axis of FIG. 13 indicates intensity of light. The unit of intensity of light is Watt/steradian.

The cylindrical lens, the lens array surface 110 and the lens array surface 120 of Example 3 are identical respectively with the cylindrical lens, the lens array surface 110 and the lens array surface 120 of Example 1. In Example 3, plural light sources, each of which is identical with the light source of Example 1, are placed in a line in the y-axis direction at intervals of 5 millimeters as shown in FIG. 11. The shapes of intensity distribution in the x-axis direction and in the y-axis direction of Example 3 are similar respectively to the shapes of intensity distribution in the x-axis direction and in the y-axis direction of Example 1. On the other hand, the intensity of light of Example 3 is greater than the intensity of light of Example 1. Thus, by placing plural light sources in a line in the y-axis direction, the intensity of light can be increased without changing the shapes of intensity distribution.

### Example 4

The optical element 300 used for determining the width of a line of the line generator of Example 4 is a cylindrical lens. Lens array surfaces 110 and 120 are provided respectively on the light entry side surface and on the light exit side surface of a single lens array element.

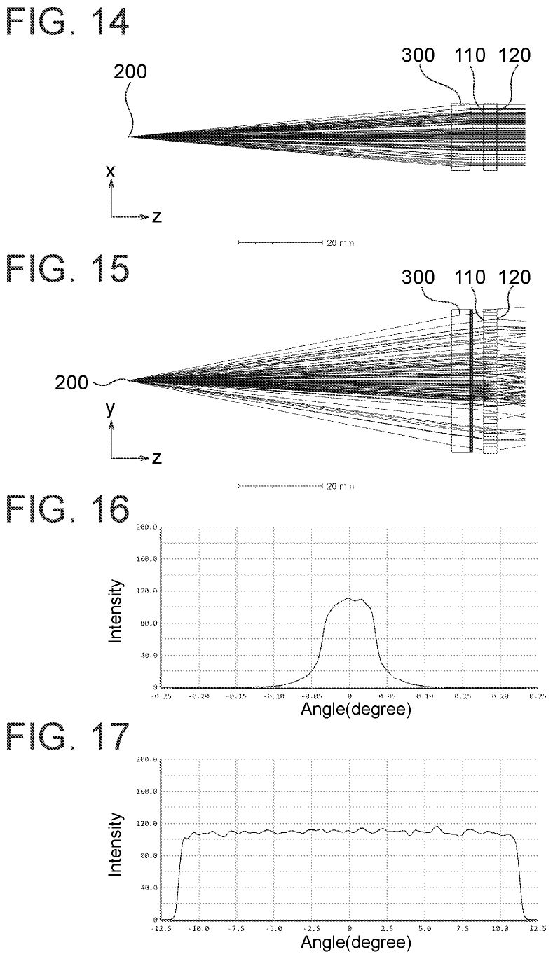

FIG. 14 shows paths of rays of light in the xz cross section of the line generator of Example 4.

FIG. 15 shows paths of rays of light in the yz cross section of the line generator of Example 4.

Numerical data of Example 4 are shown below.

| Distance from light source: | | 77 | mm |
|---|---|---|---|
| Cylindrical lens: | Light entry side surface | infinite | |
| | Light exit side surface | Rx = −40.83 mm | |
| | | k = −1.2 | |
| | Center thickness | 5 | mm |
| | Refractive index | 1.508 | |
| Distance between elements: | | 2.5 | mm |
| Lens array element: | Light entry side surface | Ry = 1.18 mm | |
| | (lens surface 1100) | k = −0.4 | |
| | Light exit side surface | Ry = −1.18 mm | |
| | (lens surface 1200) | k = −0.4 | |
| | Center thickness | 3.26 | mm |
| | Lens pitch in array | 0.8 | mm |
| | Refractive index | 1.567 | |
| Light source: | Size | 0.1 mm × 0.1 mm | |
| Size of aperture: | x-axis direction | 16 | mm |
| | y-axis direction | 34 | mm |

The lens surfaces 1100 on the lens array surface 110 and the lens surfaces 1200 on the lens array surface 120, each of which has a curvature in the y-axis direction alone, are placed respectively in a line in the y-axis direction at intervals of 0.8 millimeters.

FIG. 16 shows an intensity distribution in the x-axis direction of a light beam that has passed through the line generator of Example 4. The horizontal axis of FIG. 16 indicates angle of a ray of light with respect to the z-axis in the xz cross section. The unit of angle is degree. The vertical axis of FIG. 16 indicates intensity of light. The unit of intensity of light is Watt/steradian.

FIG. 17 shows an intensity distribution in the y-axis direction of a light beam that has passed through the line generator of Example 4. The horizontal axis of FIG. 17 indicates angle of a ray of light with respect to the z-axis in the yz cross section. The unit of angle is degree. The vertical axis of FIG. 17 indicates intensity of light. The unit of intensity of light is Watt/steradian.

The light exit surface of the cylindrical lens of the present example is aspherical. By making the light exit surface of the cylindrical lens aspherical, the intensity of light in the x-axis direction (the width direction of the line) can be made more uniform.

### Example 5

The optical element 300 used for determining the width of a line of the line generator of Example 5 is a cylindrical lens. Lens array surfaces 110 and 120 are provided respectively on the light entry side surface and on the light exit side surface of a single lens array element.

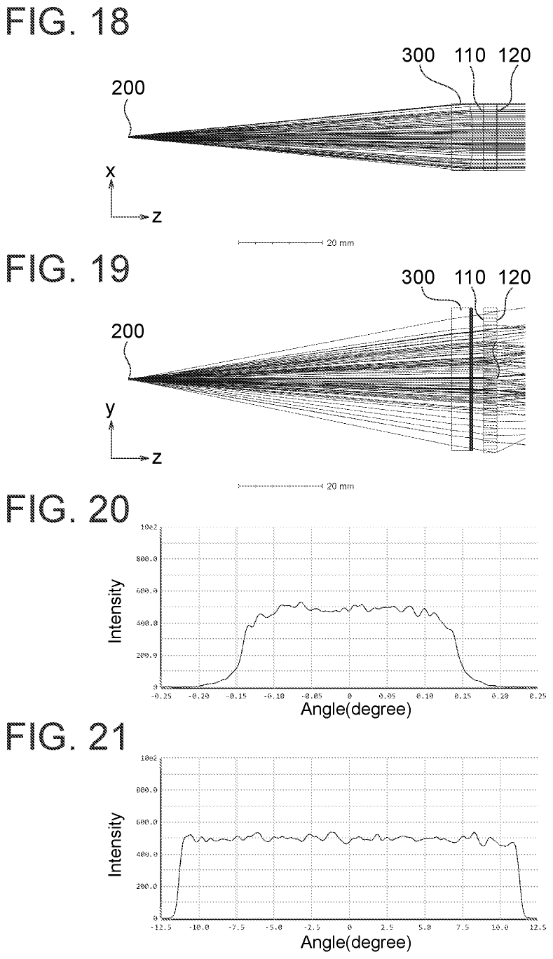

FIG. 18 shows paths of rays of light in the xz cross section of the line generator of Example 5.

FIG. 19 shows paths of rays of light in the yz cross section of the line generator of Example 5.

Numerical data of Example 5 are shown below.

| Distance from light source: | | 77 | mm |
|---|---|---|---|
| Cylindrical lens: | Light entry side surface | infinite | |
| | Light exit side surface | Rx = −40.83 mm | |
| | | k = −1.2 | |
| | Center thickness | 5 | mm |
| | Refractive index | 1.508 | |
| Distance between elements: | | 2.5 | mm |
| Lens array element: | Light entry side surface | Ry = 1.18 mm | |
| | (lens surface 1100) | k = −0.4 | |
| | Light exit side surface | Ry = −1.18 mm | |
| | (lens surface 1200) | k = −0.4 | |
| | Center thickness | 3.26 | mm |
| | Lens pitch in array | 0.8 | mm |
| | Refractive index | 1.567 | |
| Light source: | Size | 0.4 mm × 0.4 mm | |
| Size of aperture: | x-axis direction | 16 | mm |
| | y-axis direction | 34 | mm |

The lens surfaces 1100 on the lens array surface 110 and the lens surfaces 1200 on the lens array surface 120, each of which has a curvature in the y-axis direction alone, are placed respectively in a line in the y-axis direction at intervals of 0.8 millimeters.

FIG. 20 shows an intensity distribution in the x-axis direction of a light beam that has passed through the line generator of Example 5. The horizontal axis of FIG. 20 indicates angle of a ray of light with respect to the z-axis in the xz cross section. The unit of angle is degree. The vertical axis of FIG. 20 indicates intensity of light. The unit of intensity of light is Watt/steradian.

FIG. 21 shows an intensity distribution in the y-axis direction of a light beam that has passed through the line generator of Example 5. The horizontal axis of FIG. 21 indicates angle of a ray of light with respect to the z-axis in the yz cross section. The unit of angle is degree. The vertical axis of FIG. 21 indicates intensity of light. The unit of intensity of light is Watt/steradian.

The cylindrical lens, the lens array surface 110 and the lens array surface 120 of Example 5 are identical respectively with the cylindrical lens, the lens array surface 110 and the lens array surface 120 of Example 4. The light source of Example 5 is enlarged in the x-axis direction and in the y-axis direction as compared with the light source of Example 4. By enlarging the light source in the x-axis direction, the width of a line can be increased.

### Example 6

The optical element 300 used for determining the width of a line of the line generator of Example 6 is a cylindrical lens. Lens array surfaces 110 and 120 are provided respectively on the light entry side surface and on the light exit side surface of a single lens array element.

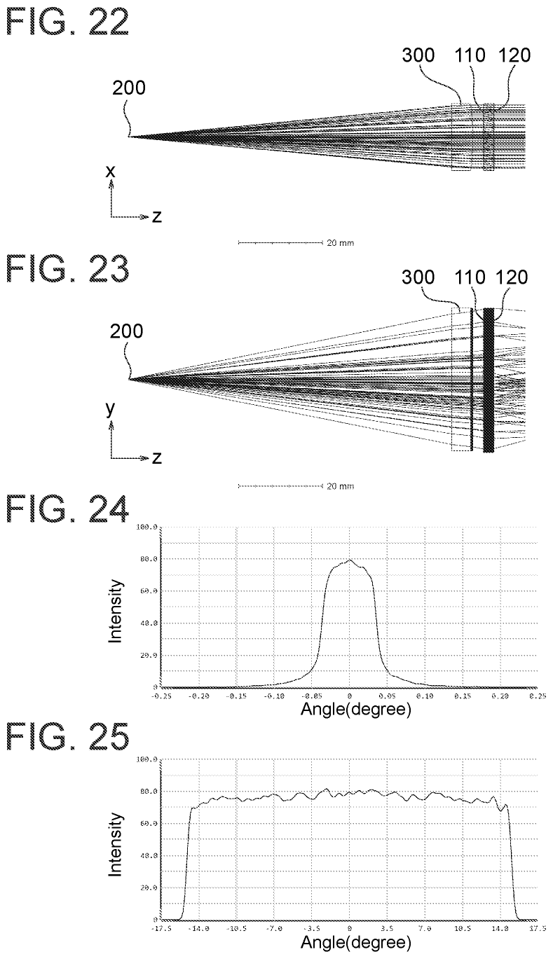

FIG. 22 shows paths of rays of light in the xz cross section of the line generator of Example 6.

FIG. 23 shows paths of rays of light in the yz cross section of the line generator of Example 6.

Numerical data of Example 6 are shown below.

| Distance from light source: | | 77 | mm |
|---|---|---|---|
| Cylindrical lens: | Light entry side surface | infinite | |
| | Light exit side surface | Rx = −60.159 mm | |
| | Center thickness | 5 | mm |
| | Refractive index | 1.707 | |
| Distance between elements: | | 2.5 | mm |
| Lens array element: | Light entry side surface | Ry = 1.00 mm | |
| | (lens surface 1100) | k = −0.4 | |
| | | A2 = 5.9749E−004 | |
| | | A4 = −4.2385E−007 | |
| | Light exit side surface | Ry = −1.00 mm | |
| | (lens surface 1200) | k = −0.4 | |
| | Center thickness | 2.58 | mm |
| | Lens pitch in array | 0.8 | mm |
| | Refractive index | 1.636 | |
| Light source: | Size | 0.1 mm × 0.1 mm | |
| Size of aperture: | x-axis direction | 16 | mm |
| | y-axis direction | 34 | mm |

The lens surfaces 1100 and the lens surfaces 1200 are placed respectively in a line in the y-axis direction at intervals of 0.8 millimeters.

FIG. 24 shows an intensity distribution in the x-axis direction of a light beam that has passed through the line generator of Example 6. The horizontal axis of FIG. 24 indicates angle of a ray of light with respect to the z-axis in the xz cross section. The unit of angle is degree. The vertical axis of FIG. 24 indicates intensity of light. The unit of intensity of light is Watt/steradian.

FIG. 25 shows an intensity distribution in the y-axis direction of a light beam that has passed through the line generator of Example 6. The horizontal axis of FIG. 25 indicates angle of a ray of light with respect to the z-axis in the yz cross section. The unit of angle is degree. The vertical axis of FIG. 25 indicates intensity of light. The unit of intensity of light is Watt/steradian.

In Example 6, each of the lens surfaces 1100 is provided with a curvature also in the x-axis direction so as to correct residual aberrations of the cylindrical lens. Consequently, intensity of light in the x-axis direction (the width direction of a line) can be made more uniform.

### Example 7

The optical element 300 used for determining the width of a line of the line generator of Example 7 is a cylindrical lens. In the present example, the lens array surfaces 110 and 120 are provided respectively on separate optical elements, a lens array element 1 and a lens array element 2. The lens array surfaces 110 form the light entry side surface of the lens array element 1, and the lens array surfaces 120 form the light exit side surface of the lens array element 2.

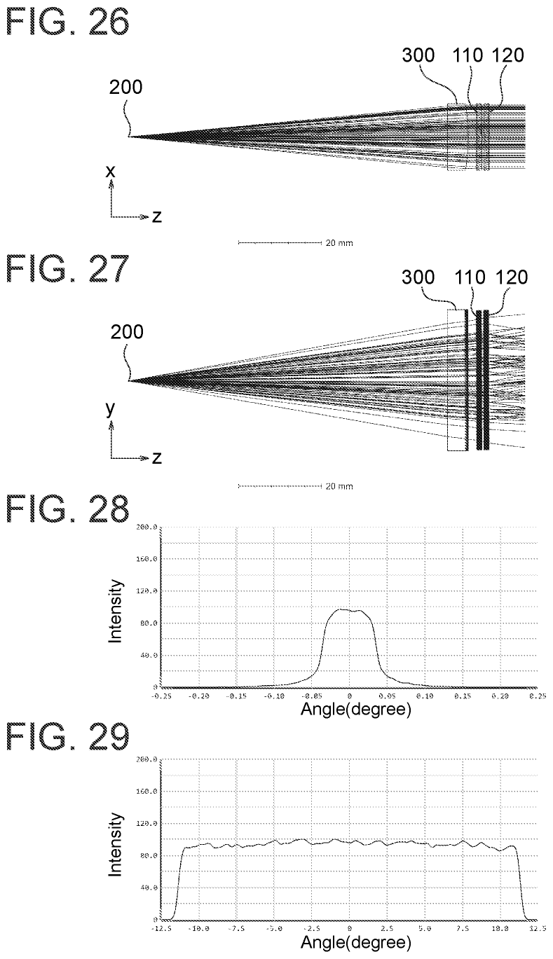

FIG. 26 shows paths of rays of light in the xz cross section of the line generator of Example 7.

FIG. 27 shows paths of rays of light in the yz cross section of the line generator of Example 7.

Numerical data of Example 7 are shown below.

| Distance from light source: | | 77 | mm |
|---|---|---|---|
| Cylindrical lens: | Light entry side surface | infinite | |
| | Light exit side surface | Rx = −45.84 mm | |
| | Center thickness | 5 | mm |
| | Refractive index | 1.509 | |
| Distance between elements: | | 2 | mm |
| Lens array element 1: | Light entry side surface | Ry = 1.27 mm | |
| | (lens surface 1100) | k = −0.5 | |
| | Light exit side surface | Rx = −914.09 mm | |
| | | A2 = 2.7664E−07 | |
| | | A4 = 7.7915E−11 | |
| | Center thickness | 1.25 | mm |
| | Refractive index | 1.614 | |
| | Lens pitch in array | 0.8 | mm |
| Distance between elements: | | 0.5 | mm |
| Lens array element 2: | Light entry side surface | Rx = 914.09 mm | |
| | | A2 = −2.7664E−07 | |
| | | A4 = −7.7915E−11 | |
| | Light exit side surface | Ry = −1.27 mm | |
| | (lens surface 1200) | k = −0.5 | |
| | Center thickness | 1.25 | mm |
| | Refractive index | 1.614 | |
| | Lens pitch in array | 0.8 | mm |
| Light source: | Size | 0.1 mm × 0.1 mm | |
| Size of aperture: | x-axis direction | 16 | mm |
| | y-axis direction | 34 | mm |

The lens surfaces 1100 and the lens surfaces 1200 are placed respectively in a line in the y-axis direction at intervals of 0.8 millimeters.

FIG. 28 shows an intensity distribution in the x-axis direction of a light beam that has passed through the line generator of Example 7. The horizontal axis of FIG. 28 indicates angle of a ray of light with respect to the z-axis in the xz cross section. The unit of angle is degree. The vertical axis of FIG. 28 indicates intensity of light. The unit of intensity of light is Watt/steradian.

FIG. 29 shows an intensity distribution in the y-axis direction of a light beam that has passed through the line generator of Example 7. The horizontal axis of FIG. 29 indicates angle of a ray of light with respect to the z-axis in the yz cross section. The unit of angle is degree. The vertical axis of FIG. 29 indicates intensity of light. The unit of intensity of light is Watt/steradian.

### Example 8

The optical element 300 used for determining the width of a line of the line generator of Example 8 is a cylindrical lens. In the present example, lens array surfaces 110 and 120 are provided respectively on separate optical elements, a lens array element 1 and a lens array element 2. The lens array surfaces 110 form the light entry side surface of the lens array element 1, and the lens array surfaces 120 form the light exit side surface of the lens array element 2. Further, the cylindrical lens is placed between the lens array element 1 and the lens array element 2.

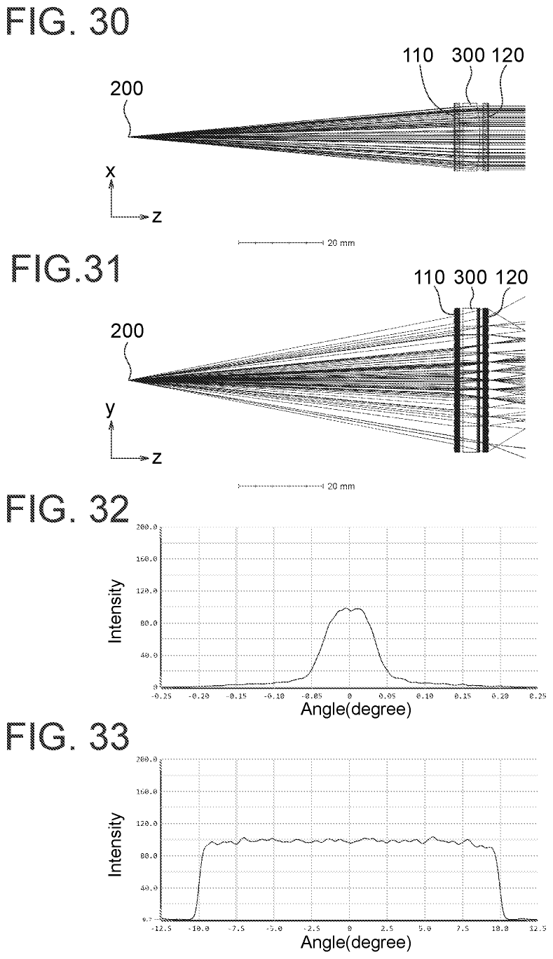

FIG. 30 shows paths of rays of light in the xz cross section of the line generator of Example 8.

FIG. 31 shows paths of rays of light in the yz cross section of the line generator of Example 8.

Numerical data of Example 8 are shown below.

| Distance from light source: | | 77 | mm |
|---|---|---|---|
| Lens array element 1: | Light entry side surface | Ry = 3.32 mm | |
| | (lens surface 1100) | k = −0.5 | |
| | Light exit side surface | Rx = −964.03 mm | |
| | | A2 = −5.9643E−07 | |
| | | A4 = 2.3729E−08 | |
| | Center thickness | 1.30 | mm |
| | Refractive index | 1.567 | |
| | Lens pitch in array | 2 | mm |
| Distance between elements: | | 0.75 | mm |
| Cylindrical lens: | Light entry side surface | Rx = infinite | |
| | Light exit side surface | Rx = −45.96mm | |
| | Center thickness | 4 | mm |
| | Refractive index | 1.509 | |
| Distance between elements: | | 0.75 | mm |
| Lens array element 2: | Light entry side surface | Rx = 964.03mm | |
| | | A2 = 5.9643E−07 | |
| | | A4 = −2.3729E−08 | |
| Light exit side surface (lens surface 1200) | | Ry = 3.32 mm | |
| | | k = −0.5 | |
| | Center thickness | 1.30 | mm |
| | Lens pitch in array | 2 | mm |
| | Refractive index | 1.567 | |
| Light source: | Size | 0.1 mm × 0.1 mm | |
| Size of aperture: | x-axis direction | 16 | mm |
| | y-axis direction | 34 | mm |

The lens surfaces 1100 and the lens surfaces 1200 are placed respectively in a line in the y-axis direction at intervals of 2 millimeters.

FIG. 32 shows an intensity distribution in the x-axis direction of a light beam that has passed through the line generator of Example 8. The horizontal axis of FIG. 32 indicates angle of a ray of light with respect to the z-axis in the xz cross section. The unit of angle is degree. The vertical axis of FIG. 32 indicates intensity of light. The unit of intensity of light is Watt/steradian.

FIG. 33 shows an intensity distribution in the y-axis direction of a light beam that has passed through the line generator of Example 8. The horizontal axis of FIG. 33 indicates angle of a ray of light with respect to the z-axis in the yz cross section. The unit of angle is degree. The vertical axis of FIG. 33 indicates intensity of light. The unit of intensity of light is Watt/steradian.

### Example 9

The optical element 300 used for determining the width of a line of the line generator of Example 9 is a cylindrical mirror that has a curvature in the x-axis direction alone. Lens array surfaces 110 and 120 are provided respectively on the light entry side surface and on the light exit side surface of a single lens array element.

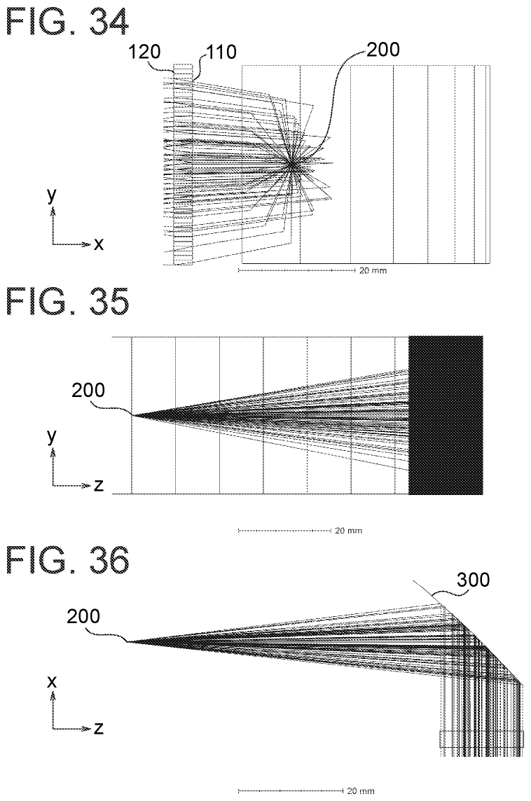

FIG. 34 shows paths of rays of light in the xy cross section of the line generator of Example 9.

FIG. 35 shows paths of rays of light in the yz cross section of the line generator of Example 9.

FIG. 36 shows paths of rays of light in the zx cross section of the line generator of Example 9.

Numerical data of Example 9 are shown below.

| Distance from light source: | | 68 | mm |
|---|---|---|---|
| Cylindrical mirror: | Light entry side surface | A2 = −7.3529E−03 | |
| Distance between elements: | | 17 | mm |
| Lens array element: | Light entry side surface | Ry = 1.18 mm | |
| | (lens surface 1100) | k = −0.4 | |
| | Light exit side surface | Ry = 1.18 mm | |
| | (lens surface 1200) | k = −0.4 | |
| | Center thickness | 3.26 | mm |
| | Refractive index | 1.567 | |
| | Lens pitch in array | 0.8 | mm |
| Light source: | Size | 0.1 mm × 0.1 mm | |
| Size of aperture: | Line with direction | 16 | mm |
| | Line longitudinal direction | 34 | mm |

The lens surfaces 1100 and the lens surfaces 1200 are placed respectively in a line in the y-axis direction at intervals of 0.8 millimeters.

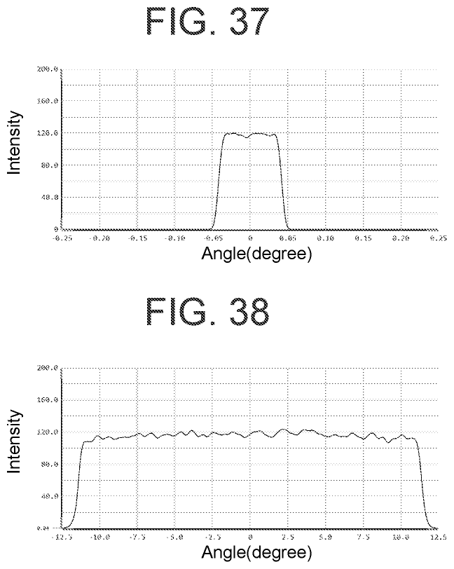

FIG. 37 shows an intensity distribution in the line width direction of a light beam that has passed through the line generator of Example 9. The horizontal axis of FIG. 37 indicates angle of a ray of light with respect to the z-axis in the xz cross section. The unit of angle is degree. The vertical axis of FIG. 37 indicates intensity of light. The unit of intensity of light is Watt/steradian.

FIG. 38 shows an intensity distribution in the line longitudinal direction (the y-axis direction) of a light beam that has passed through the line generator of Example 9. The horizontal axis of FIG. 38 indicates angle of a ray of light with respect to the x-axis in the xy cross section. The unit of angle is degree. The vertical axis of FIG. 38 indicates intensity of light. The unit of intensity of light is Watt/steradian.

### Example 10

The optical element 300 used for determining the width of a line of the line generator of Example 10 is a cylindrical mirror that has a curvature in the x-axis direction alone. Lens array surfaces 110 and 120 are provided respectively on the light entry side surface and on the light exit side surface of a single lens array element.

FIG. 39 shows paths of rays of light in the xy cross section of the line generator of Example 10.

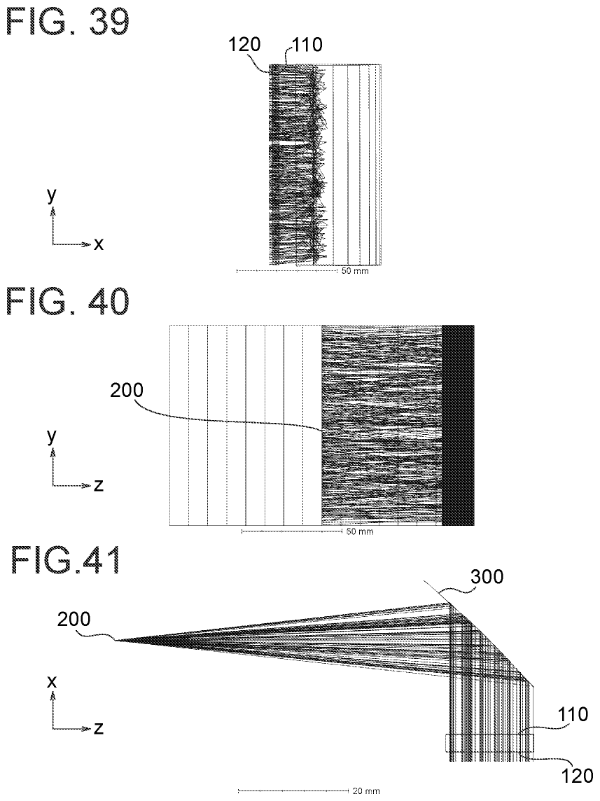

FIG. 40 shows paths of rays of light in the yz cross section of the line generator of Example 10.

FIG. 41 shows paths of rays of light in the zx cross section of the line generator of Example 10.

Numerical data of Example 10 are shown below.

| Distance from light source: | | 68 | mm |
|---|---|---|---|
| Cylindrical mirror: | Light entry side surface | A2 = −7.3529E−03 | |
| Distance between elements: | | 17 | mm |
| Lens array element: | Light entry side surface | Ry = 1.18 mm | |
| | (lens surface 1100) | k = −0.4 | |
| | Light exit side surface | Ry = 1.18 mm | |
| | (lens surface 1200) | k = −0.4 | |
| | Center thickness | 3.26 | mm |
| | Refractive index | 1.567 | |
| | Lens pitch in array | 0.8 | mm |
| Light source: | Size | 0.1 mm × 100 mm | |
| Size of aperture: | Line with direction | 16 | mm |
| | Line longitudinal direction | 100 | mm |

The lens surfaces 1100 and the lens surfaces 1200 are placed respectively in a line in the y-axis direction at intervals of 0.8 millimeters.

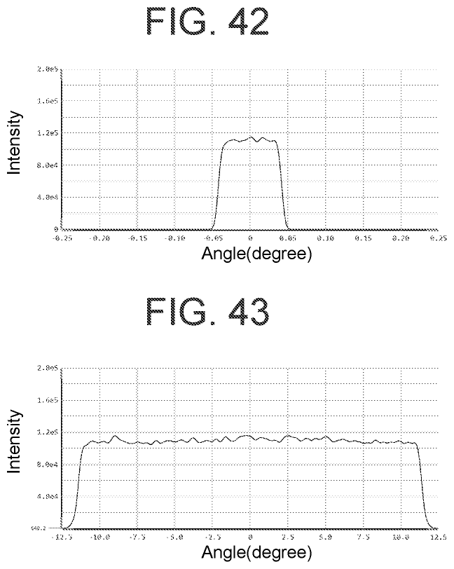

FIG. 42 shows an intensity distribution in the line width direction (the z-axis direction) of a light beam that has passed through the line generator of Example 10. The horizontal axis of FIG. 42 indicates angle of a ray of light with respect to the z-axis in the xz cross section. The unit of angle is degree. The vertical axis of FIG. 42 indicates intensity of light. The unit of intensity of light is Watt/steradian.

FIG. 43 shows an intensity distribution in the line longitudinal direction (the y-axis direction) of a light beam that has passed through the line generator of Example 10. The horizontal axis of FIG. 43 indicates angle of a ray of light with respect to the x-axis in the xy cross section. The unit of angle is degree. The vertical axis of FIG. 43 indicates intensity of light. The unit of intensity of light is Watt/steradian.

The cylindrical mirror, the lens array surface 110 and the lens array surface 120 of Example 10 are identical respectively with the cylindrical mirror, the lens array surface 110 and the lens array surface 120 of Example 9. The light source of Example 10 is enlarged in the y-axis direction as compared with the light source of Example 9 as shown in FIG. 40. The shapes of intensity distribution in the z-axis direction and in the y-axis direction of Example 10 are similar respectively to the shapes of intensity distribution in the z-axis direction and in the y-axis direction of Example 9. On the other hand, the intensity of light of Example 10 is greater than the intensity of light of Example 9. Thus, by enlarging the light source in the y-axis direction, the intensity of light can be increased without changing the shapes of intensity distribution.

### Example 11

The optical element 300 used for determining the width of a line of the line generator of Example 11 is a cylindrical mirror that has a curvature in the x-axis direction alone. Lens array surfaces 110 and 120 are provided respectively on the light entry side surface and on the light exit side surface of a single lens array element.

FIG. 44 shows paths of rays of light in the xy cross section of the line generator of Example 11.

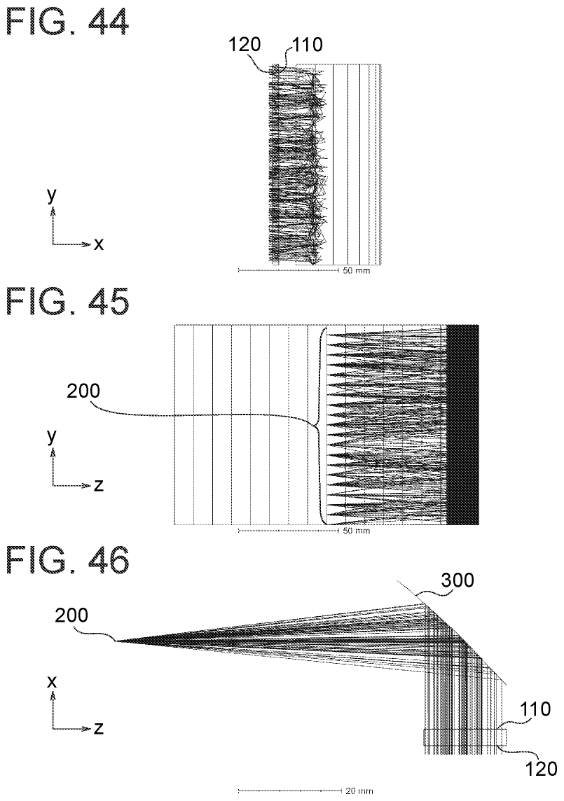

FIG. 45 shows paths of rays of light in the yz cross section of the line generator of Example 11.

FIG. 46 shows paths of rays of light in the zx cross section of the line generator of Example 11.

Numerical data of Example 11 are shown below.

| Distance from light source: | | 68 | mm |
|---|---|---|---|
| Cylindrical mirror: | Light entry side surface | A2 = −7.3529E−03 | |
| Distance between elements: | | 17 | mm |
| Lens array element: | Light entry side surface | Ry = 1.18 mm | |
| | (lens surface 1100) | k = −0.4 | |
| | Light exit side surface | Ry = 1.18 mm | |
| | (lens surface 1200) | k = −0.4 | |
| | Center thickness | 3.26 | mm |
| | Refractive index | 1.567 | |
| | Lens pitch in array | 0.8 | mm |
| Light source: | Size | 0.1 mm × 0.1 mm | |
| | Light source pitch | 5 | mm |
| Size of aperture: | Line with direction | 16 | mm |
| | Line longitudinal direction | 100 | mm |

The lens surfaces 1100 and the lens surfaces 1200 are placed respectively in a line in the y-axis direction at intervals of 0.8 millimeters.

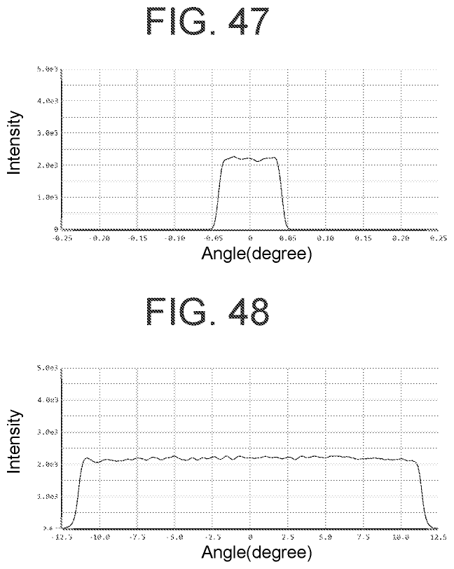

FIG. 47 shows an intensity distribution in the line width direction (the z-axis direction) of a light beam that has passed through the line generator of Example 11. The horizontal axis of FIG. 47 indicates angle of a ray of light with respect to the z-axis in the xz cross section. The unit of angle is degree. The vertical axis of FIG. 47 indicates intensity of light. The unit of intensity of light is Watt/steradian.

FIG. 48 shows an intensity distribution in the line longitudinal direction (the y-axis direction) of a light beam that has passed through the line generator of Example 11. The horizontal axis of FIG. 48 indicates angle of a ray of light with respect to the x-axis in the xy cross section. The unit of angle is degree. The vertical axis of FIG. 48 indicates intensity of light. The unit of intensity of light is Watt/steradian.

The cylindrical mirror, the lens array surface 110 and the lens array surface 120 of Example 11 are identical respectively with the cylindrical mirror, the lens array surface 110 and the lens array surface 120 of Example 9. In Example 11, plural light sources, each of which is identical with the light source of Example 9, are placed in a line in the y-axis direction at intervals of 5 millimeters as shown in FIG. 45. The shapes of intensity distribution in the x-axis direction and in the y-axis direction of Example 11 are similar respectively to the shapes of intensity distribution in the x-axis direction and in the y-axis direction of Example 9. On the other hand, the intensity of light of Example 11 is greater than the intensity of light of Example 9. Thus, by placing plural light sources in a line in the y-axis direction, the intensity of light can be increased without changing the shapes of intensity distribution.

### Example 12

The optical element 300 used for determining the width of a line of the line generator of Example 12 is a cylindrical mirror that has a curvature in the x-axis direction alone. Lens array surfaces 110 and 120 are provided respectively on the light entry side surface and on the light exit side surface of a single lens array element.

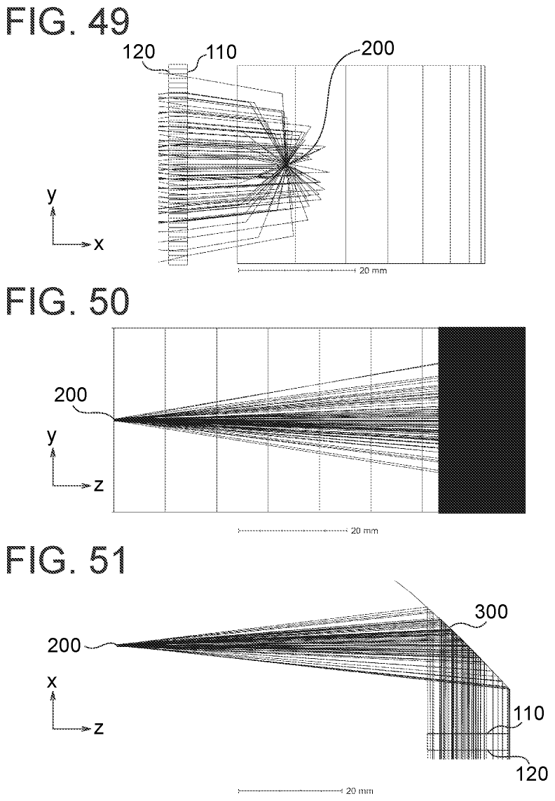

FIG. 49 shows paths of rays of light in the xy cross section of the line generator of Example 12.

FIG. 50 shows paths of rays of light in the yz cross section of the line generator of Example 12.

FIG. 51 shows paths of rays of light in the zx cross section of the line generator of Example 12.

Numerical data of Example 12 are shown below.

| Distance from light source: | | 68 | mm |
|---|---|---|---|
| Cylindrical mirror: | Light entry side surface | A2 = −7.3529E−03 | |
| Distance between elements: | | 17 | mm |
| Lens array element: | Light entry side surface | Ry = 1.18 mm | |
| | (lens surface 1100) | k = −0.4 | |
| | Light exit side surface | Ry = 1.18 mm | |
| | (lens surface 1200) | k = −0.4 | |
| | Center thickness | 3.26 | mm |
| | Refractive index | 1.567 | |
| | Lens pitch in array | 0.8 | mm |
| Light source: | Size | 0.4 mm × 0.4 mm | |
| Size of aperture: | Line with direction | 16 | mm |
| | Line longitudinal direction | 34 | mm |

The lens surfaces 1100 and the lens surfaces 1200 are placed respectively in a line in the y-axis direction at intervals of 0.8 millimeters.

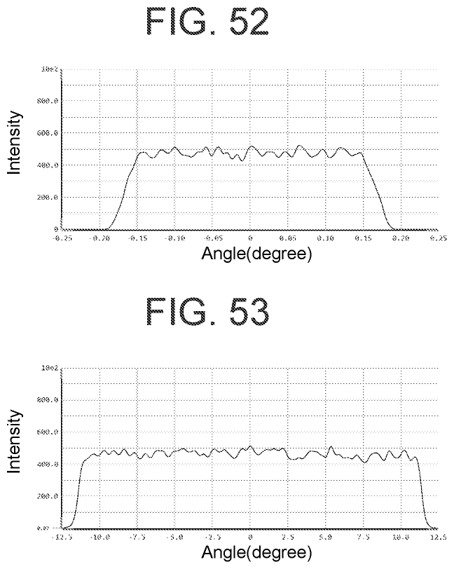

FIG. 52 shows an intensity distribution in the line width direction (the z-axis direction) of a light beam that has passed through the line generator of Example 12. The horizontal axis of FIG. 52 indicates angle of a ray of light with respect to the z-axis in the xz cross section. The unit of angle is degree. The vertical axis of FIG. 52 indicates intensity of light. The unit of intensity of light is Watt/steradian.

FIG. 53 shows an intensity distribution in the line longitudinal direction (the y-axis direction) of a light beam that has passed through the line generator of Example 12. The horizontal axis of FIG. 53 indicates angle of a ray of light with respect to the x-axis in the xy cross section. The unit of angle is degree. The vertical axis of FIG. 53 indicates intensity of light. The unit of intensity of light is Watt/steradian.

The cylindrical mirror, the lens array surface 110 and the lens array surface 120 of Example 12 are identical respectively with the cylindrical mirror, the lens array surface 110 and the lens array surface 120 of Example 9. The light source of Example 12 is enlarged in the x-axis direction and in the y-axis direction as compared with the light source of Example 9. By enlarging the light source in the x-axis direction, the line width can be increased.

### Example 13

The optical element 300 used for determining the width of a line of the line generator of Example 13 is a cylindrical lens. Lens array surfaces 110 and 120 are provided respectively on the light entry side surface and on the light exit side surface of a single lens array element.

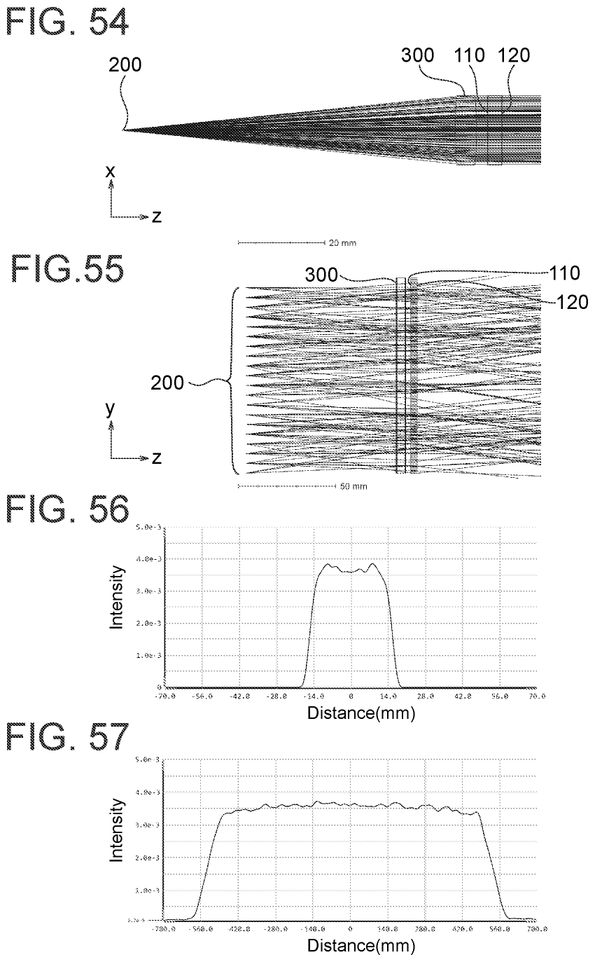

FIG. 54 shows paths of rays of light in the xz cross section of the line generator of Example 13.

FIG. 55 shows paths of rays of light in the yz cross section of the line generator of Example 13.

Numerical data of Example 13 are shown below.

| Distance from light source: | | 77 | mm |
|---|---|---|---|
| Cylindrical lens: | Light entry side surface | Rx = 82.79 mm | |
| | Light exit side surface | Rx = −82.79 mm | |
| | Center thickness | 5 | mm |
| | Refractive index | 1.509 | |
| Distance between elements: | | 2.5 | mm |
| Lens array element: | Light entry side surface | Ry = 1.15 mm | |
| | (lens surface 1100) | k = −0.49 | |
| | Light exit side surface | Ry = −1.15 mm | |
| | (lens surface 1200) | k = −0.49 | |
| | Center thickness | 3.48 | mm |
| | Lens pitch in array | 0.8 | mm |
| | Refractive index | 1.489 | |
| Light source: | Size | 0.1 mm × 0.1 mm | |
| | Light source pitch | 5 | mm |
| Size of aperture: | x-axis direction | 16 | mm |
| | y-axis direction | 100 | mm |
| Projection distance: | | 3000 | mm |

The lens surfaces 1100 and the lens surfaces 1200 are placed respectively in a line in the y-axis direction at intervals of 0.8 millimeters.

FIG. 56 shows an intensity distribution in the line width direction (the x-axis direction) on an illuminated surface at the distance of 3000 millimeters from the light source of a light beam that has passed through the line generator of Example 13. The horizontal axis of FIG. 56 indicates distance from the central axis of the light beam. The unit of distance is millimeter. The vertical axis of FIG. 56 indicates intensity of light. The unit of intensity of light is Watt/square centimeter.

FIG. 57 shows an intensity distribution in the line longitudinal direction (the y-axis direction) on an illuminated surface at the distance of 3000 millimeters from the light source of a light beam that has passed through the line generator of Example 13. The horizontal axis of FIG. 57 indicates distance from the central axis of the light beam. The unit of distance is millimeter. The vertical axis of FIG. 57 indicates intensity of light. The unit of intensity of light is Watt/square centimeter.

Each of the line generators of Examples 1 to 12 has an infinite conjugated system and projects a line onto an illuminated surface at a distance. In the line generator of Example 13, the cylindrical lens is configured so as to project a line onto an illuminated surface at the distance of 3000 mm from the light source. The present invention is applicable to the case where a relationship between the light source and the illuminated optical system is that of a finite conjugate system and the case where a relationship between the light source and the illuminated optical system is that of an infinite conjugate system.

In Example 13, plural light sources are placed in a line in the y-axis direction at intervals of 5 millimeters as shown in FIG. 55. Thus, by placing plural light sources in a line in the y-axis direction, the intensity of light can be increased without changing the shapes of intensity distribution.

### Example 14

The optical element 300 used for determining the width of a line of the line generator of Example 14 is composed of two cylindrical lenses 300A and 300B. Lens array surfaces 110 and 120 are provided respectively on the light entry side surface and on the light exit side surface of a single lens array element. The two cylindrical lenses 300A and 300B are provided respectively on the light source side of the lens array element and on the opposite side of the lens array element from the light source. The cylindrical lens 300B is also referred to as a project lens.

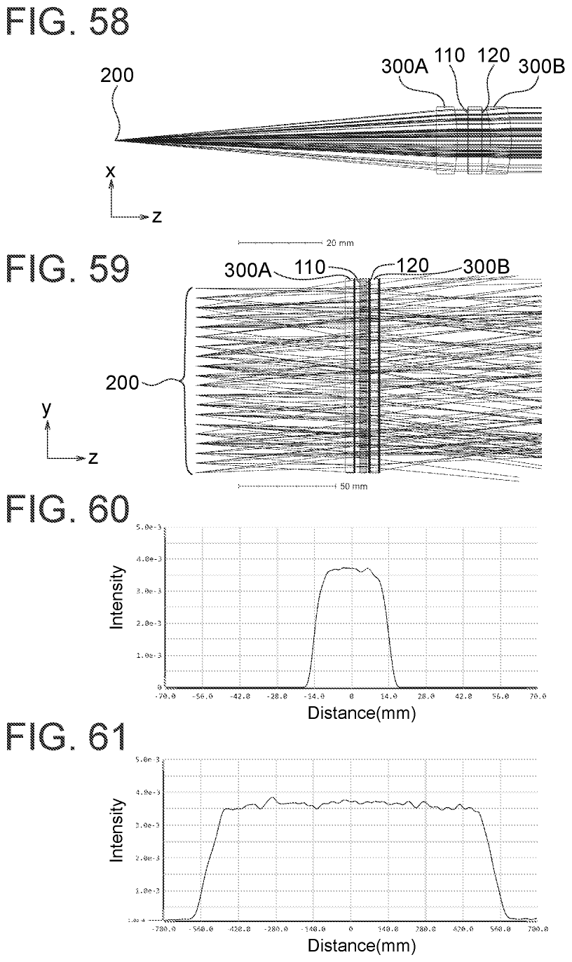

FIG. 58 shows paths of rays of light in the xz cross section of the line generator of Example 14.

FIG. 59 shows paths of rays of light in the yz cross section of the line generator of Example 14.

Numerical data of Example 14 are shown below.

| Distance from light source: | | 77 | mm |
|---|---|---|---|
| Cylindrical lens (300A): | Light entry side surface | Rx = infinite | |
| | Light exit side surface | Rx = −41.35 mm | |
| | Center thickness | 5 | mm |
| | Refractive index | 1.509 | |
| Distance between elements: | | 2.5 | mm |
| Lens array element: | Light entry side surface | Ry = 1.15 mm | |
| | (lens surface 1100) | k = −0.49 | |
| | Light exit side surface | Ry = −1.15 mm | |
| | (lens surface 1200) | k = −0.49 | |
| | Center thickness | 3.48 | mm |
| | Lens pitch in array | 0.8 | mm |
| | Refractive index | 1.489 | |
| Distance between elements: | | 2 | mm |
| Projection lens (300B): | Light entry side surface | Rx = −30.14 mm | |
| | Light exit side surface | Rx = −32.37 mm | |
| | Center thickness | 5 | mm |
| | Center thickness | 1.509 | |
| Light source: | Size | 0.1 mm × 0.1 mm | |
| | Light source pitch | 5 | mm |
| Size of aperture: | x-axis direction | 16 | mm |
| | y-axis direction | 100 | mm |
| Projection distance: | | 3000 | mm |

The lens surfaces 1100 and the lens surfaces 1200 are placed respectively in a line in the y-axis direction at intervals of 0.8 millimeters.

FIG. 60 shows an intensity distribution in the line width direction (the x-axis direction) on an illuminated surface at the distance of 3000 millimeters from the light source of a light beam that has passed through the line generator of Example 14. The horizontal axis of FIG. 60 indicates distance from the central axis of the light beam. The unit of distance is millimeter. The vertical axis of FIG. 60 indicates intensity of light. The unit of intensity of light is Watt/square centimeter.

FIG. 61 shows an intensity distribution in the line longitudinal direction (the y-axis direction) on an illuminated surface at the distance of 3000 millimeters from the light source of a light beam that has passed through the line generator of Example 14. The horizontal axis of FIG. 61 indicates distance from the central axis of the light beam. The unit of distance is millimeter. The vertical axis of FIG. 61 indicates intensity of light. The unit of intensity of light is Watt/square centimeter.

In the optical system of the line generator of Example 14, a cylinder lens is added as a projection lens on the opposite side (on the projection side) of the first and the second lens array surfaces from the light source of the Example 2. Thus, a system that is configured by adding a projection lens to any of the optical systems of Examples 1 to 12 that are designed as an infinite conjugated system can also be used.

What is claimed is:

1. An optical system for a line generator that generates a line using a light beam, comprising:
an optical element having a curvature in a first direction alone; and
first and second lens array surfaces;
where each of the first and second lens array surfaces is provided with plural toroidal lens surfaces arranged in a line in a second direction orthogonal to the first direction, each of the plural toroidal lens surfaces has a curvature mainly in the second direction, any toroidal lens surface on one of the first and second lens array surfaces corresponds to one of the toroidal lens surfaces on the other, the direction of a first straight line connecting the vertexes of two toroidal lens surfaces corresponding to each other is orthogonal to the second direction, and in a cross section containing the first straight line and a second straight line that is in the second direction and orthogonal to the first straight line, one of the two toroidal lens surfaces is configured so as to form an imaging surface of the other for the object point at infinity.

2. The optical system for a line generator according to claim 1, wherein a curvature in the first direction of each of the toroidal lens surfaces is 0 or ten times less than the curvature in the second direction.

3. The optical system for a line generator according to claim 1, wherein a curvature in the first direction of each of the toroidal lens surfaces is determined so as to correct aberrations of the optical element.

4. The optical system for a line generator according to claim 1, wherein the first and second lens array surfaces are provided on a single lens.

5. The optical system for a line generator according to claim 1, wherein the first and second lens array surfaces are provided respectively on different lenses.

6. The optical system for a line generator according to claim 1, wherein the optical element is a cylindrical lens.

7. The optical system for a line generator according to claim 1, wherein the optical element is a cylindrical mirror.

8. A line generator comprising an optical system for a line generator according to claim 1 and a light source.

9. The line generator according to claim 8 wherein the length in the second direction of the light source is greater than the length in the first direction.

10. The line generator according to claim 8 wherein the light source is composed of plural light sources arranged in a line in the second direction.

11. A distance measuring system that uses the line generator according to claim 8 as a light source.
